(19) United States
(12) Patent Application Publication
(10) Pub. No.: US 2025/0323255 A1
(43) Pub. Date: Oct. 16, 2025

(54) LITHIUM AND MANGANESE RICH POSITIVE ACTIVE MATERIAL COMPOSITIONS

(71) Applicant: FORD GLOBAL TECHNOLOGIES, LLC, Dearborn, MI (US)

(72) Inventors: Eunsung LEE, Novi, MI (US); Chi PAIK, Grosse Ile, MI (US); Jason Aaron LUPESCU, Wayne, MI (US); Yisun CHENG, Ann Arbor, MI (US); Robert J. KUDLA, Canton, MI (US); Deepali KOZAREKAR, Novi, MI (US); Mary FREDRICK, Carleton, MI (US); Patrick BONNICK, Ann Arbor, MI (US); Liyuan SUN, Ann Arbor, MI (US)

(21) Appl. No.: 18/631,999

(22) Filed: Apr. 10, 2024

(51) Int. Cl. H01M 4/505; C01G 53/00; H01M 4/02; H01M 10/0525

(52) U.S. Cl. CPC H01M 4/505; C01G 53/50; H01M 10/0525; C01P 2002/52; C01P 2006/40; H01M 2004/028

(57) ABSTRACT

A positive electrode active material for lithium-ion batteries may include a compound represented by a general formula 1: Li_{1.02 to 1.08}Mn_{0.51 to 0.52}Ni_{0.40 to 0.47-x}CoₓO₂, where x ranges from 0 to 0.1. The average oxidation state of manganese is controlled to be between 3.8 and 4.0. The average oxidation state of nickel is maintained at less than 2.27. A battery may contain the positive electrode.

### TECHNICAL FIELD

In at least one aspect, positive electrode active materials for lithium-ion batteries are provided.

### BACKGROUND

Lithium and Manganese Rich (LMR) positive electrode active material has been considered a promising next-generation cathode material due to its high gravimetric energy density compared to currently used Nickel Cobalt Manganese (NCM) and Nickel Cobalt Aluminum (NCA) materials.

### SUMMARY

In at least one aspect, a positive electrode active material is provided for lithium-ion batteries. This material includes a compound represented by the general formula 1: Li_{1.02 to 1.08}Mn_{0.51 to 0.52}Ni_{0.40 to 0.47-x}MₓO₂, wherein M is Co, Cr, or a combination thereof, and 0<x≤0.1. The positive electrode active material may have the average oxidation state of manganese (Mn) controlled between 3.8 and 4.0. Additionally, the positive electrode active material may have the average oxidation state of nickel (Ni) controlled to be less than 2.10. When the lithium (Li) content is 1.02, the manganese content may be 0.51, and the nickel content may follow the formula 0.47−x, where 0<x≤0.1. When the lithium content is adjusted to 1.08, the manganese content may be set at 0.52, and the nickel content may adhere to the formula 0.40−x. For these configurations, x ranges either from 0.04 to less than 0.1, with the average oxidation state of Ni being 2.0 and the average oxidation state of Mn between 3.9 and 4.0, or from greater than 0 to less than 0.04, where the average oxidation state of Ni is between 2.0 and 2.1 and the average oxidation state of Mn is 4.0. The positive electrode active material may be incorporated into a cathode, which, when packed with an anode and electrolyte, forms a lithium-ion battery.

Another aspect provides a positive electrode for a lithium-ion battery. This electrode includes a positive electrode active material with a compound represented by the chemical formula 1: Li_{1.08}Mn_{0.52}Ni_{0.40-x}MₓO₂, wherein M is Co, Cr, or a combination thereof, and 0<x≤0.1. For these configurations, x ranges either from 0.04 to less than 0.1, with the average oxidation state of Ni being 2.0 and the average oxidation state of Mn between 3.9 and 4.0, or from greater than 0 to less than 0.04, where the average oxidation state of Ni is between 2.0 and 2.1 and the average oxidation state of Mn is 4.0. This positive electrode may be assembled with a negative electrode and an electrolyte to create a lithium-ion battery.

In yet another aspect, a rechargeable lithium-ion battery with at least one lithium-ion battery cell is provided. Each cell includes a positive electrode comprising a positive electrode active material as represented by formula 1: Li_{1.02}Mn_{0.51}Ni_{0.47-x}MₓO₂, a negative electrode including a negative active material, and an electrolyte, wherein M is Co, Cr, or a combination thereof, and 0<x<0.1. The rechargeable lithium-ion battery may have the Mn in the positive electrode active material's average oxidation state controlled between 3.8 and 4.0 and the Ni's average oxidation state controlled to 2.0. The battery may feature a plurality of these cells, possibly forming a battery pack, and each cell may also include a separator placed between the positive and negative electrodes. Furthermore, each of the lithium-ion battery cells may exhibit a specific capacity greater than 200 mAh/g.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A is a schematic view, in cross-section, of a positive electrode that includes cathode active material on a single side of a current collector;

FIG. 1B is a schematic view, in cross-section, of a positive electrode that includes cathode active material on both sides of a current collector;

FIG. 2 is a schematic view, in cross-section, of a battery cell that includes the positive electrode of FIG. 1A; and

FIG. 3 is a schematic view, in cross-section, of a battery pack that includes the battery cells of FIG. 2.

### DETAILED DESCRIPTION

Reference will now be made in detail to presently preferred compositions, embodiments, and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Unless expressly stated to the contrary, when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It should be noted that, as used in the specification and the appended claims, the singular form “a,” “an,” and “the” comprise plural referents unless the context clearly indicates otherwise. For example, reference to a component in the singular is intended to comprise a plurality of components. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps. The phrase “composed of” means “including” or “consisting of.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1, the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

The term “positive electrode” means a battery cell electrode from which current flows out when the lithium-ion battery cell or battery is discharged. Sometimes a “positive electrode” is referred to as a “cathode.” The term “negative electrode” means a battery cell electrode to which current flows in when the lithium-ion battery cell is discharged. Sometimes a “negative electrode” is referred to as an “anode.” The term “cell” or “battery cell” means an electrochemical cell made of at least one positive electrode, at least one negative electrode, an electrolyte, and a separator membrane. The term “battery” or “battery pack” means an electric storage device made of at least one battery cell. In a refinement, “battery” or “battery pack” is an electric storage device made of a plurality of battery cells. The term “specific capacity” means the capacity per unit mass of the active material. Specific capacity has units of milliamp hours/gram (mAh/g).

There are intrinsic issues with current LMR material compositions such as voltage decay during cycling, rate capability, cycle performance, and volumetric energy density. Accordingly, there is a need for optimized LMR material compositions for positive electrode active materials for lithium-ion batteries with increased rate capability, cell performance, and volumetric energy density.

The present disclosure provides compositions for Lithium Manganese Rich (LMR) cathodes used in lithium-ion batteries. The performance issues inherent to conventional LMR compositions may include voltage decay during cycling, decreased rate capability over successive cycles, and poor cycle performance. These issues may be mitigated by optimizing the composition of the LMR.

In one or more embodiments of this disclosure, the LMR compositions are optimized to have lower Li content (Li₂MnO₃) than conventional compositions. This modification betters the cycle performance, power performance, and rate capability by enhancing the voltage decay suppression, and electronic and ionic conductivity of the LMR. However, it is recognized that lower Li content typically results in lower capacity than conventional LMR.

To counteract potential reductions in capacity, the composition of LMR materials for lithium-ion batteries has been refined to increase Nickel (Ni) content while optimizing the amount of Cobalt (Co) or Chromium (Cr). This adjustment aims to increase the overall capacity, primarily through the role of Ni, by controlling its average oxidation state to less than 2.27, and Mn, controlling its average oxidation state between 3.80 and 4.00. Simultaneously, the optimized Co content plays a role in increasing both electronic and ionic conductivity.

In one aspect of the disclosure a composition represented by the formula Li_{1.02 to 1.08}Mn_{0.51 to 0.52}Ni_{0.40 to 0.47-x}MₓO₂, where M is Co, Cr, or a combination thereof, and x ranges from 0 to 0.1. This configuration aims to address aspects such as cycle performance, power efficiency, and rate capability. In another aspect of the disclosure, for specific applications that require high power efficiency and stable cycle performance, the composition Li_{1.02}Mn_{0.51}Ni_{0.47-x}MₓO₂, where M is Co, Cr, or a combination thereof, and x ranges from 0 to 0.1. This adjustment takes advantage of the electronic conductivity of Co to potentially increase battery performance. The inclusion of Co, in combination with the adjusted ratios of Li, Mn, and Ni, aims to increase the battery's durability and efficiency. This approach is intended to maintain that the average oxidation states of Mn and Ni are within targeted ranges, contributing to the overall increase in electrochemical properties and longevity of lithium-ion batteries.

In another aspect of the disclosure, for applications valuing higher energy density and increased rate capability, an alternative composition, Li_{1.08}Mn_{0.52}Ni_{0.40-x}MₓO₂, where M is Co, Cr, or a combination thereof, and x ranges from 0 to 0.1. This version is designed to support higher capacity in demanding conditions, facilitated by increased contents of Li and Mn, and the benefits of incorporating Co. The presence of Co, noted for its electronic conductivity, along with its role in electrochemical stability, is expected to increase the battery's performance and durability. The flexibility in adjusting x allows for the electrochemical characteristics of the material to be fine-tuned, aiming to meet the performance requirements of various applications.

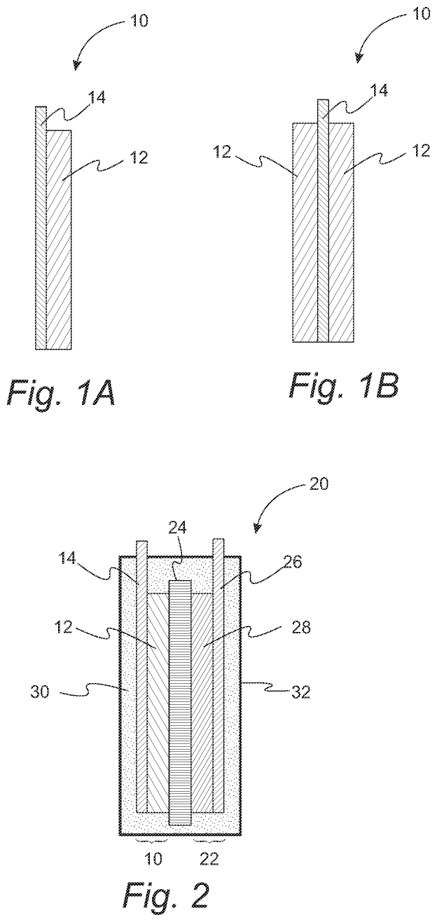

Referring to FIG. 1, a schematic of a positive electrode that includes a positive electrode active material is provided. Positive electrode 10 includes positive electrode active material layer 12 of positive electrode active material disposed over and typically contacting positive electrode current collector 14. Typically, the positive electrode current collector 14 is a metal plate or metal foil composed of a metal such as aluminum, copper, platinum, zinc, titanium, and the like. Currently, aluminum is most commonly used for the positive electrode current collector. The positive electrode active material is represented by formula 1:

Li_{1.02 to 1.08}Mn_{0.51 to 0.52}Ni_{0.40 to 0.47-x}MₓO₂ (1)
wherein:
M is Co, Cr, or a combination thereof; and
0<x≤0.1.

A specific active electrode composition is Li_{1.02}Mn_{0.51}Ni_{0.47-x}MₓO₂ for applications requiring increased power efficiency and robust cycle performance. In this formulation, Co, Cr, or a combination thereof, serve to adjust the material's electrochemical properties to meet varied operational demands. The average oxidation state of the Ni ion is controlled at 2.0, optimizing the capacity contributions from Ni, and the average oxidation state of Mn is maintained between 3.8 and 4.0, aiming for a balance between capacity, stability, and overall performance. The choice of x within the range of 0 to 0.1 allows for fine-tuning of the composition to achieve desired outcomes.

In another formulation, a specific active electrode composition of Li_{1.08}Mn_{0.52}Ni_{0.40-x}MₓO₂ is presented. This formulation is configured for applications that value higher energy density. This variant features slightly higher contents of Li and Mn to support the battery's ability to exhibit high capacity under specific conditions. With Co included to bolster the structural stability and electrochemical performance, the variable x, set within the 0 to 0.1 range, enables modulation of the composition to optimize performance according to tailored needs. For these configurations, x ranges either from 0.04 to less than 0.1, with the average oxidation state of Ni being 2.0 and the average oxidation state of Mn between 3.9 and 4.0, or from greater than 0 to less than 0.04, where the average oxidation state of Ni is between 2.0 and 2.1 and the average oxidation state of Mn is 4.0. These detailed specific active electrode compositions may be incorporated into a cathode, which, when combined with an anode and electrolyte, forms a comprehensive lithium-ion battery.

With reference to FIG. 2, a schematic of a rechargeable lithium-ion battery cell incorporating the positive electrode of FIG. 1 is provided. Battery cell 20 includes the positive electrode 10 as described above, negative electrode 22, and separator 24 interposed between the positive electrode 10 and the negative electrode 22. The negative electrode 22 includes a negative electrode current collector 26 and a negative active material layer 28 disposed over and typically contacting the negative electrode current collector 26. Typically, the negative electrode current collector 26 is a metal plate or metal foil composed of a metal such as aluminum, copper, platinum, zinc, titanium, and the like. Currently, copper is most commonly used for the negative electrode current collector 26. The battery cell 20 is immersed in electrolyte 30 which is enclosed by battery cell case 32. The electrolyte 30 imbibes into the separator 24. In other words, the separator 24 includes the electrolyte thereby allowing lithium ions to move between the negative and positive electrodes. The electrolyte 30 includes a non-aqueous organic solvent and a lithium salt. The non-aqueous organic solvent serves as a medium for transmitting ions taking part in the electrochemical reaction of a battery. Advantageously, the battery cell 20 may have a specific capacity of greater than 200 mAh/g.

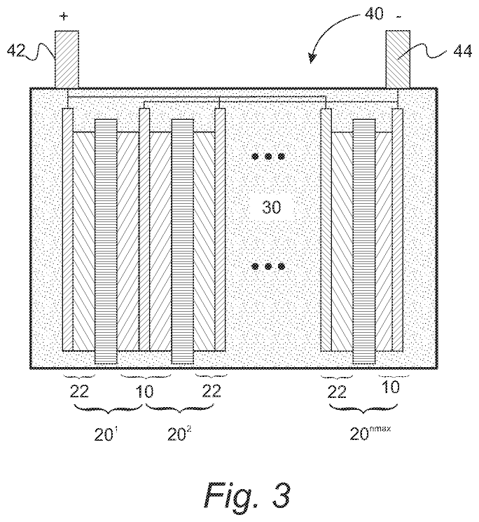

With reference to FIG. 3, a schematic of a rechargeable lithium-ion battery incorporating the positive electrode of FIG. 1 and the battery cells of FIG. 2 is provided. Rechargeable lithium-ion battery 40 includes at least one battery cell of the design in FIG. 2. Typically, the rechargeable lithium-ion battery 40 includes at least one battery cell 20i of the design of FIG. 2. Each of the lithium-ion battery cells 20i includes the positive electrode 10 which includes the compound represented by formula 1, the negative electrode 22 which includes a negative active material, and the electrolyte 30, where i is an integer label for each battery cell. The label i runs from 1 to nmax, where nmax is the total number of battery cells in the rechargeable lithium-ion battery 40. The electrolyte 30 includes a non-aqueous organic solvent and a lithium salt. The non-aqueous organic solvent serves as a medium for transmitting ions taking part in the electrochemical reaction of a battery. The plurality of battery cells may be wired in series, in parallel, or a combination thereof. The voltage output from the battery 40 is provided across terminals 42 and 44. Advantageously, the rechargeable lithium-ion battery 40 may have a specific capacity of greater than 200 mAh/g for each battery cell therein.

Referring to FIGS. 2 and 3, the separator 24 physically separates the negative electrode 22 from the positive electrode 10 thereby preventing shorting while allowing the transport of lithium ions for charging and discharging. Therefore, the separator 24 may be composed of any material suitable for this purpose. Examples of suitable materials from which the separator 24 may be composed include but are not limited to, polytetrafluoroethylene (e.g., TEFLON®), glass fiber, polyester, polyethylene, polypropylene, and combinations thereof. The separator 24 may be in the form of either a woven or non-woven fabric. The separator 24 may be in the form of a non-woven fabric or a woven fabric. For example, a polyolefin-based polymer separator such as polyethylene and/or polypropylene is typically used for a lithium-ion battery. To ensure heat resistance or mechanical strength, a coated separator includes a coating of ceramic, or a polymer material may be used.

Referring to FIGS. 2 and 3, the electrolyte 30 includes a lithium salt dissolved in the non-aqueous organic solvent. Therefore, the electrolyte 30 includes lithium ions that may intercalate into the positive electrode active material during discharging and into the anode active material during charging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, and combinations thereof. In a refinement, the electrolyte includes the lithium salt in an amount from about 0.1 M to about 2.0 M.

Still referring to FIGS. 2 and 3, the electrolyte includes a non-aqueous organic solvent and a lithium salt. Advantageously, the non-aqueous organic solvent serves as a medium for transmitting ions, and in particular, lithium ions participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvents include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent may be used singularly. In other variations, mixtures of the non-aqueous organic solvent may be used. Such mixtures are typically formulated to optimize battery performance. In a refinement, a carbonate-based solvent is prepared by mixing a cyclic carbonate and a linear carbonate. In a variation, the electrolyte 30 may further include vinylene carbonate or an ethylene carbonate-based compound to increase battery cycle life.

Referring to FIGS. 1, 2, and 3, the negative electrode and the positive electrode may be fabricated by methods known to those skilled in the art of lithium-ion batteries. Typically, an active material (e.g., the positive or negative active material) is mixed with a conductive material, and a binder in a solvent (e.g., N-methylpyrrolidone) is mixed into an active material composition and coated on the current collector. The electrode manufacturing method is well known and thus is not described in detail in the present specification. The solvent includes N-methylpyrrolidone and the like but is not limited thereto.

Referring to FIGS. 1, 2, and 3, the positive electrode active material layer 12 includes the positive electrode active material represented by formula 1, a binder, and a conductive material. The binder may increase the binding properties of positive electrode active material particles with one another and with the positive electrode current collector 14. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides the positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, and 3, the negative active material layer 26 includes a negative active material, a binder, and optionally a conductive material. The negative active materials used herein may be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide may be described by the formula SiO_{z} where z is from 0.09 to 1.1. Mixtures of carbon-based negative active materials or silicon-based negative active materials may also be used for the negative active material.

The negative electrode binder increases the binding properties of negative active material particles with one another and with a current collector. The binder may be a non-aqueous binder, an aqueous binder, or a combination thereof. Examples of non-aqueous binders may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders may be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol, and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A positive electrode active material for lithium-ion batteries, comprising a compound represented by a general formula 1:
Li_{1.02 to 1.08}Mn_{0.51 to 0.52}Ni_{0.40 to 0.47-x}MₓO₂ (1),
wherein:
M is Co, Cr, or a combination thereof; and
0<x≤0.1.

2. The positive electrode active material of claim 1 wherein an average oxidation state of Mn is between 3.8 and 4.0.

3. The positive electrode active material of claim 2 wherein an average oxidation state of Ni is less than 2.10.

4. The positive electrode active material of claim 1 wherein when a Li content is 1.02, a Mn content is 0.51, and a Ni content is represented by a formula 0.47−x, where 0<x≤0.1.

5. The positive electrode active material of claim 4 wherein an average oxidation state of Mn is between 3.8 and 4.0.

6. The positive electrode active material of claim 5 wherein an average oxidation state of Ni is 2.0.

7. The positive electrode active material of claim 1 wherein when a Li content is 1.08, a Mn content is 0.52, and a Ni content is represented by a formula 0.40−x.

8. The positive electrode active material of claim 7 wherein 0.04<x<0.1, an average oxidation state of Ni is 2.0, and an average oxidation state of Mn is between 3.9 and 4.0.

9. The positive electrode active material of claim 8 wherein 0≤x<0.04, an average oxidation state of Ni is between 2.0 and 2.1, and an average oxidation state of Mn is 4.0.

10. A positive electrode for a lithium-ion battery, the positive electrode comprising a positive electrode active material comprising a compound represented by chemical formula 1:
Li_{1.08}Mn_{0.52}Ni_{0.40-x}MₓO₂ (1),
wherein:
M is Co, Cr, or a combination thereof; and
0<x≤0.1.

11. The positive electrode active material of claim 10 wherein 0.04<x<0.1, an average oxidation state of Ni is 2.0, and an average oxidation state of Mn is between 3.9 and 4.0.

12. The positive electrode active material of claim 10 wherein 0<x<0.04, an average oxidation state of Ni is between 2.0 and 2.1, and an average oxidation state of Mn is 4.0.

13. The positive electrode of claim 10 wherein the positive electrode is packed with a negative electrode and an electrolyte to form a lithium-ion battery.

14. A rechargeable lithium-ion battery comprising at least one lithium-ion battery cell, each lithium-ion battery cell including:
a positive electrode comprising a positive electrode active material as represented by formula 1:
Li_{1.02}Mn_{0.51}Ni_{0.47-x}MₓO₂ (1)
wherein:
M is Co, Cr, or a combination thereof;
0<x≤0.1;
a negative electrode including a negative active material; and
an electrolyte.

15. The rechargeable lithium-ion battery of claim 14, wherein Mn in the positive electrode active material has an average oxidation state of between 3.8 and 4.0.

16. The rechargeable lithium-ion battery of claim 14, wherein Ni in the positive electrode active material has an average oxidation state of 2.0.

17. The rechargeable lithium-ion battery of claim 14 wherein the at least one lithium-ion battery cell is a plurality of battery cells.

18. The rechargeable lithium-ion battery of claim 14 wherein the at least one lithium-ion battery cell includes a separator interposed between the positive electrode and the negative electrode.

19. The rechargeable lithium-ion battery of claim 15 wherein the at least one lithium-ion battery cell has a specific capacity greater than 200 mAh/g.
